(19) United States
(12) Patent Application Publication
(10) Pub. No.: US 2025/0154991 A1
(43) Pub. Date: May 15, 2025

(54) MULTI-PISTON DISENGAGEMENT SYSTEM FOR A BRAKE DEVICE OF A VEHICLE, BRAKE DEVICE FOR A VEHICLE HAVING A MULTI-PISTON DISENGAGEMENT SYSTEM, AND TRANSMISSION ARRANGEMENT FOR A VEHICLE HAVING THE BRAKE DEVICE

(71) Applicant: Schaeffler Technologies AG & Co. KG, Herzogenaurach (DE)

(72) Inventor: Simon Ortmann, Pulheim (DE)

(73) Assignee: Schaeffler Technologies AG & Co. KG, Herzogenaurach (DE)

(21) Appl. No.: 18/833,917

(22) PCT Filed: Jan. 19, 2023
(86) PCT No.: PCT/DE2023/100038

§ 371 Date: Jul. 29, 2024

(30) Foreign Application Priority Data
Feb. 11, 2022 (DE) 10 2022 103 228.0

(51) Int. Cl. F16D 55/40; B60T 1/06; F16D 55/00; F16D 65/18; F16D 121/04; F16D 125/06; F16H 57/02

(52) U.S. Cl. CPC F16D 55/40; B60T 1/062; F16D 65/186; F16D 2055/0091; F16D 2121/04; F16D 2125/06; F16H 2057/02026; F16H 2057/02043

(57) ABSTRACT

A multi-piston disengagement system for a vehicle brake mechanism includes an annular housing. The annular housing includes a main axis defining an axial direction and an axial opposite direction, and a plurality of housing sections. Each of the plurality of housing sections includes a pressure chamber arranged to be filled with a fluid and an actuating arrangement. The actuating arrangement includes a first piston assembly having a first piston that, when subjected to a hydraulic pressure, is movable in a first actuation stroke to introduce a first actuating force into a brake device of the vehicle brake mechanism, and a second piston assembly having a second piston that, when subjected to a hydraulic pressure, is movable in a second actuation stroke to introduce a second actuating force into the brake device of the vehicle brake mechanism.

### CROSS-REFERENCE TO RELATED APPLICATIONS

This application is the United States National Phase of PCT Appln. No. PCT/DE2023/100038 filed Jan. 19, 2023, which claims priority to German Application No. DE102022103228.0 filed Feb. 11, 2022, the entire disclosures of which are incorporated by reference herein.

### TECHNICAL FIELD

The present disclosure relates to a multi-piston disengagement system for a brake mechanism of a vehicle, a brake mechanism for a vehicle having the multi-piston disengagement system, and a transmission arrangement for a vehicle having the brake mechanism.

### BACKGROUND

Piston disengagement systems for actuating clutches or brakes in an electric drive train of a vehicle are well known from the prior art. For example, document DE 10 2020 104 771 A1 describes a slave cylinder for a disengagement system of a vehicle having a housing which forms a pressure chamber and having a piston which is arranged to be axially movable in the pressure chamber. In order to operate a clutch, the piston can introduce an actuating force into the clutch.

### SUMMARY

The present disclosure provides a multi-piston disengagement system which is designed for integration into a brake mechanism of a vehicle. The multi-piston disengagement system may be designed to actuate a brake device, wherein the brake device is a component of the brake mechanism. For example, the brake device is a wet-running multi-disc service brake, which can be arranged or is arranged within a wet space of an electric vehicle or hybrid vehicle. The multi-disc service brake may have a disc pack arrangement with a plurality of friction discs. The wet space can be formed by a transmission housing of a transmission arrangement for the vehicle. The vehicle may be an electric vehicle, e.g., an electrically or hybrid powered car or commercial vehicle.

The multi-piston disengagement system includes an annular housing. The annular housing has a main axis that defines an axial direction. The annular housing may be arranged to be concentric to the main axis.

The annular housing may have at least one flow channel, a fluid inlet and a plurality of pressure chambers which are fluidically connected to one another. A fluid, for example, a hydraulic fluid, may be introduced into the flow channel through the fluid inlet and flow from there into the pressure chambers.

The annular housing includes a plurality of housing sections. In each housing section there is at least one pressure chamber that can be filled and/or is filled with the fluid. The at least one pressure chamber may be introduced into the housing section and/or formed therein.

The multi-piston disengagement system includes a plurality of hydraulic actuating arrangements. Some or all of the actuating arrangements may be spaced apart from one another in the circumferential direction around the annular housing. The annular housing and the resulting annular multi-piston disengagement system can be integrated into the brake mechanism and/or the transmission housing in a space-saving manner.

Each actuating arrangement includes exactly one piston assembly, and the piston assembly has a hydraulically movable piston. When hydraulic pressure is applied, the piston can perform an actuating stroke to introduce an actuating force into the brake device. During and/or after the carrying out of the actuating stroke, the piston may introduce a compressive force as an actuating force into a disc pack arrangement of the brake device, wherein the disc pack includes a plurality of friction discs. The actuating force causes the friction discs of the disc pack arrangement to be pressed together in a frictional-fitting manner to generate a braking force. For example, the multi-piston disengagement system includes eight, ten, twelve, fourteen, or sixteen piston assemblies.

Each actuating arrangement may include a spring assembly which includes a return device. The return device may be designed to reset the piston of the respective actuating arrangement, e.g., to return it to the starting position. The piston may perform a return stroke when it is returned by means of the return device.

According to the disclosure, each housing section is assigned a first actuating arrangement with a first piston assembly and a second actuating arrangement with a second piston assembly. Exactly two actuating arrangements may be arranged on each housing section. The first piston assembly includes a first piston and the second piston assembly comprises a second piston. Exactly two pistons may be arranged on each housing section.

In an example embodiment, exactly one pressure chamber is arranged in each housing section. The first piston of the first actuating arrangement and the second piston of the second actuating arrangement, which are assigned to exactly one housing section, may be arranged to be hydraulically movable in the pressure chamber of the housing section. The first piston and the second piston may share the pressure chamber as a common pressure chamber.

A further embodiment provides that the first piston can carry out the actuating stroke in the pressure chamber in the axial direction. The second piston may carry out the actuating stroke in the pressure chamber in an axially opposite direction. The two pistons may move in opposite directions when hydraulic pressure is applied in the pressure chamber.

A possible structural implementation provides that the pressure chamber includes a first pressure chamber section and a second pressure chamber section, and the first pressure chamber section is fluidically connected to the second pressure chamber section. The first piston may be arranged in the first pressure chamber section so as to be hydraulically movable in the axial direction and the second piston may be arranged in the second pressure chamber section so as to be hydraulically movable in the axial opposite direction. For example, the two pressure chamber sections are divided into sections by at least one end stop, whereby the pistons rest against the at least one end stop in the initial position and are returned thereto after the actuating stroke. Optionally, both pistons use the same end stop or each piston can be assigned its own end stop.

In a further possible constructive implementation, each housing section has a plane that is at an angle to the main axis, e.g., at a right angle. The plane may run between the first pressure chamber section and the second pressure chamber section. Optionally, the first actuating arrangement and the second actuating arrangement are arranged and/or formed opposite one another and/or in mirror image with respect to the plane. Alternatively, the first actuating arrangement and the second actuating arrangement are arranged axially and/or radially offset from one another with respect to the plane.

In a further embodiment, each actuating arrangement of the multi-piston disengagement system includes a retaining plate. In the event that the actuating arrangement includes the first piston assembly with the first piston, the retaining plate may be placed in the axial direction on the housing section associated with the actuating arrangement. In the event that the actuating arrangement includes the second piston assembly with the second piston, the retaining plate may be placed in the axially opposite direction on the housing section associated with the actuating arrangement. The retaining plate may be connected to the housing section in a force-fitting and/or form-fitting manner, for example by being screwed thereto.

In a possible constructive implementation, the spring assembly includes a spring sheet, a spring plate and a spiral spring. The spring plate may be connected to the spring sheet in a form-fitting and/or force-fitting manner. The spiral spring may be arranged between the spring plate and the retaining plate. The spiral spring may be supported with one end on the retaining plate and the other end on the spring plate.

In a further possible constructive implementation, the spring assembly is operatively connected to the piston assembly of the corresponding actuating arrangement so that the piston assembly entrains the spring assembly when carrying out the actuating stroke and the return stroke. For example, the respective piston of the piston assembly is connected to the spring sheet in a form-fitting and/or force-fitting manner. The piston may press against the spring sheet when it carries out the actuating stroke. As a result, the spring sheet and the spring plate attached thereto are moved against the preloading of the spiral spring in the axial direction if it is the first piston, or in the opposite axial direction if it is the second piston. When the hydraulic pressurization of the respective piston decreases, it is returned to the starting position by the preload of the coil spring. the spiral spring may serve as a return device.

A possible embodiment provides that the first piston is arranged and/or designed to introduce the actuating force into the disc pack arrangement in the axial direction during the actuating stroke, e.g., when the multi-piston brake system is integrated in the brake mechanism. The friction discs may be placed against one another in a frictional-fitting manner in the axial direction to generate the braking force. The multi-piston disengagement system may include a force distribution device which is designed to distribute the actuating force of the first piston in the direction of rotation of the annular housing and to introduce it into the disc pack arrangement via a plurality of force introduction regions. For example, the force distribution device includes a force distribution ring. The force distribution ring may be arranged to be coaxial and/or concentric to the annular housing in relation to the main axis. The force distribution device may be moved in the axial direction during the actuating stroke of the first piston, for example by being arranged directly in front of the first piston in the axial direction and/or by being operatively connected to the first piston. The force distribution device may be transferred into a contact position with the disc pack arrangement during the actuating stroke of the first piston, in which it presses against the force distribution device.

An example implementation provides that the multi-piston disengagement system includes a pressure transmission device. The pressure transmission device may be designed and/or arranged to transmit the actuating force transmitted by the second piston to the disc pack arrangement and/or to introduce it thereinto. The pressure transmission device may be operatively connected to the second piston for this purpose.

In one possible embodiment, the pressure transmission device includes at least one connecting device, e.g., an annular connecting sheet or a plurality of connecting rods. Optionally, the pressure transmission device additionally includes at least one traction device, e.g., a tension rod. The traction device may be operatively connected to the connecting device, e.g., pressed together therewith.

In a further possible embodiment, the connecting device is operatively connected to the second piston. For this purpose, the connecting device may be operatively connected in the axial opposite direction to the spring sheet, which is operatively connected to the second piston. For example, the connecting device and the spring sheet are connected in a form-fitting and/or force-fitting manner, e.g., by being screwed to the latter. The connecting device may be moved together with the spring sheet in the axial opposite direction when the second piston carries out the actuating stroke. For example, the traction device extends from the spring sheet in the axial direction. The traction device may be transferred into a pressure position by the connecting device during the actuating stroke of the second piston. In the pressure position, the traction device may exert a compressive force directed in the axially opposite direction against the disc pack arrangement, wherein it encompasses the disc pack arrangement at least in sections for this purpose, e.g., if the multi-piston disengagement system forms a component of the brake mechanism. The traction device may be arranged and/or designed such that it can introduce the compressive force into the disc pack arrangement in the axially opposite direction, so that the friction discs are thereby placed against one another in a frictional-fitting engaged manner in the axially opposite direction to generate the braking force.

The actuating forces of the first piston and the second piston can be introduced into the disc pack arrangement in the axial direction and in the axial opposite direction if the multi-piston disengagement system is integrated in the brake mechanism. The friction plates of the disc pack arrangement can therefore be pressed together from both sides and placed against one another in a frictional-fitting manner. This allows an external force flow of the brake device to be avoided. The frictional connection may be closed and/or the brake actuation in the installation space, e.g., in the wet chamber surrounded by the transmission housing, may take place without axial force. Here, the force level of the brake device can be maximized.

The present disclosure also provides a braking system for a vehicle having the multi-piston disengagement system according to the previous description. The brake mechanism includes a brake device for generating a braking force. The multi-piston disengagement system may form an actuator device for activating the brake device.

The brake device has a disc pack arrangement with a plurality of friction discs. The disc pack arrangement may be arranged to be coaxial and/or concentric to the main axis. The friction plates are inner plates, which are arranged to rotate, for example, and outer plates, which are arranged to be rotationally fixed, for example. The inner discs may be carried, for example, by a rotatable inner disc carrier. The friction plates may be arranged and/or designed to be movable in the axial direction and in the axial opposite direction, e.g., to be displaceable relative to one another.

In an example embodiment, the at least one connecting device of the pressure transmission device of the multi-piston disengagement system extends in the axial direction through the disc pack, e.g., through the outer discs. The traction device may encompass the outermost friction plate arranged in the axial direction, e.g., the outer plate, at least in sections, and presses thereagainst in the pressure position, so that the friction plates of the disc pack arrangement are placed against one another in a frictional-fitting manner in the opposite axial direction and can generate the braking force.

In a further embodiment, the force distribution device of the multi-piston disengagement system presses in the contact position against the outermost friction plate arranged in the axial opposite direction, e.g., the outer plate, so that the friction plates of the disc pack arrangement are placed against one another in a frictional-fitting manner in the axial direction and can generate the braking force.

is the present disclosure also provides a transmission arrangement for a vehicle. The transmission arrangement includes a transmission housing, a transmission, e.g., a planetary transmission, and the brake mechanism according to the previous description. The transmission and the brake mechanism are housed in the transmission housing.

Optionally, the annular housing of the multi-piston disengagement system has at least one fastening interface by means of which it is attached to the transmission housing. The at least one fastening interface can be formed, for example, by a plurality of screw devices, a locking ring concentric and/or coaxial with the main axis or a central nut concentric with the main axis. Here, braking torques when the brake device is actuated can be supported via the transmission housing by means of the multi-piston disengagement system.

The outer plates may engage in a form-fitting manner in the transmission housing so that they are secured against rotation and so that they can move in the axial direction and in the axial opposite direction. The brake mechanism, in particular the braking device, may be arranged in the transmission housing in such a way that it radially encloses the transmission relative to the main axis.

### BRIEF DESCRIPTION OF THE DRAWINGS

Further features, advantages, and effects of the present disclosure arise from the following description of exemplary embodiments. In the figures:

FIG. 1 shows a perspective plan view of a brake mechanism for a vehicle;

FIG. 2 shows a plan view of the brake mechanism in an axially opposite direction;

FIG. 3 shows a sectional view of the brake mechanism of FIG. 2 along the section line B-B; and

FIG. 4 shows a cross-section of the brake mechanism from FIG. 2 along the section line A-A.

### DETAILED DESCRIPTION

Corresponding or identical parts are designated with the same reference symbols in the figures.

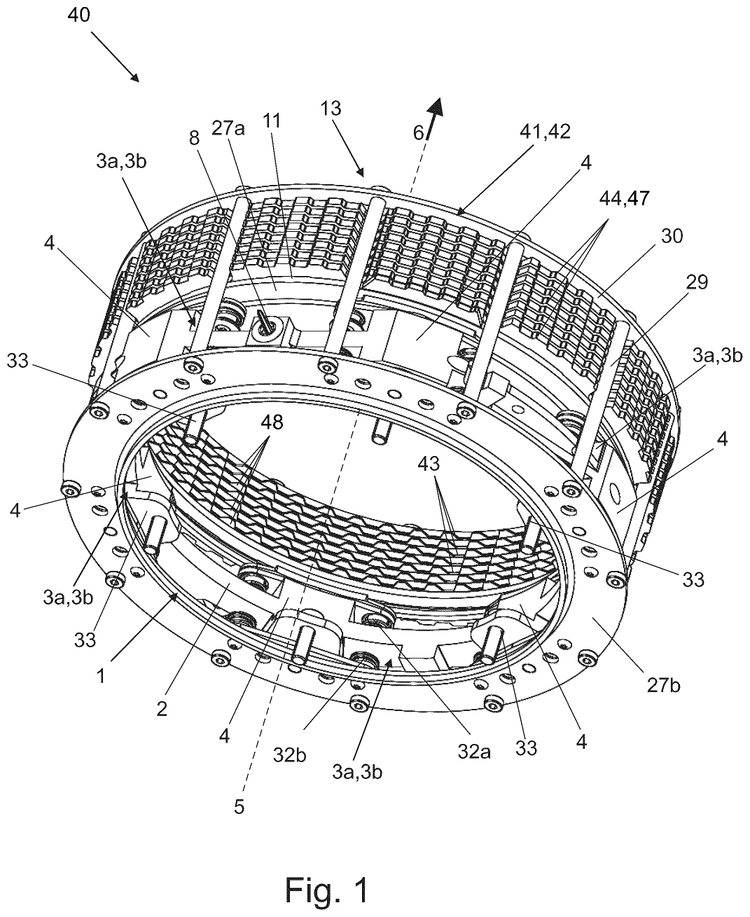

FIG. 1 shows a perspective plan view of a brake mechanism 40 for a vehicle. The brake mechanism 40 can form a component of a transmission arrangement with a transmission housing filled with a wet space fluid and with a transmission, e.g., with a planetary transmission. It can be arranged together with the transmission in the transmission housing and generate there a braking force for braking at least one component of the transmission. The transmission and the brake mechanism 40 are arranged to be concentric and/or coaxial with respect to a main axis 5 of the brake mechanism 40, and the brake mechanism 40 radially surrounds the transmission. The main axis 5 defines an axial direction 6.

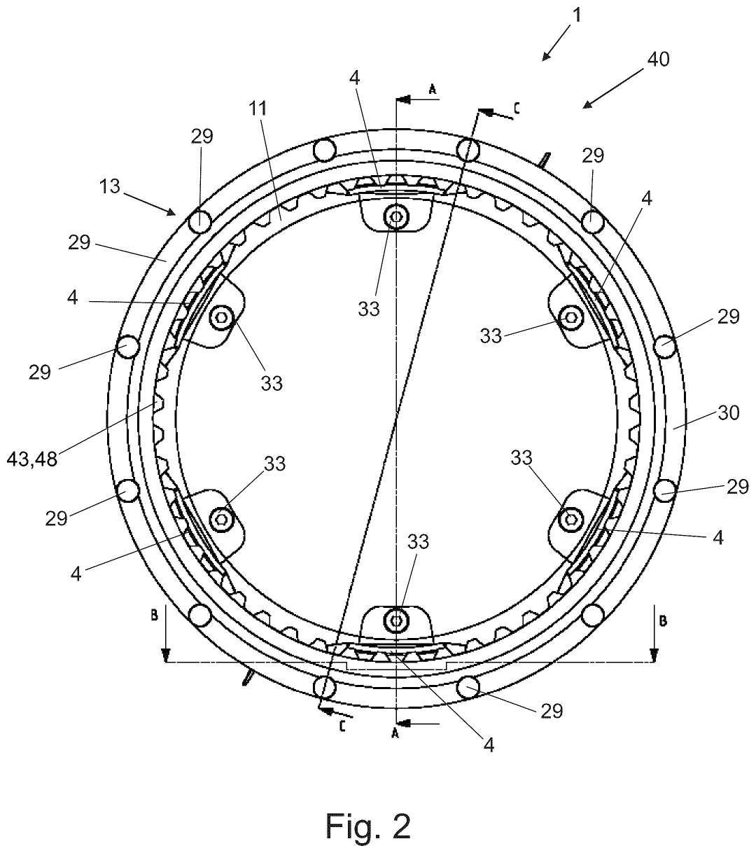

FIG. 2 shows the brake mechanism 40 in a plan view in an axial opposite direction. Referring to FIGS. 1 and 2, the brake mechanism 40 has a brake device 41 which is designed as a wet-running friction disc brake. The brake device 41 has a disc pack arrangement 42 with rotatable inner discs 43 and with rotationally fixed outer discs 44. The discs 43, 44 are arranged to be movable, e.g., displaceable, in the axial direction 6 and in an axial opposite direction. The outer plates 44 engage with an external toothing 47 in a form-fitting manner in the transmission housing so that they are axially movable and at the same time are secured against rotation about the main axis 5. The inner discs 43 are arranged on a rotatable inner disc carrier. Due to the axial movement, the plates 43, 44 can be placed against one another in a frictional-fitting manner and thus generate a braking force to slow down the component of the transmission. For this purpose, the inner plates 43 have an internal toothing 48 with which they can mesh with a suitable toothing of the component.

The brake mechanism 40 has a multi-piston disengagement system 1, which forms an actuator device for actuating the brake device by transmitting and introducing pressure forces as actuating forces. The multi-piston disengagement system 1 is arranged to be concentric and/or coaxial to the brake device 41 in relation to the main axis 5. It has an annular housing 2 and a plurality of, e.g., twelve, actuating arrangements 3a, 3b. The actuating arrangements 3a, 3b are arranged in the circumferential direction of the annular housing 2 on the annular housing 2, and are incorporated thereinto in sections.

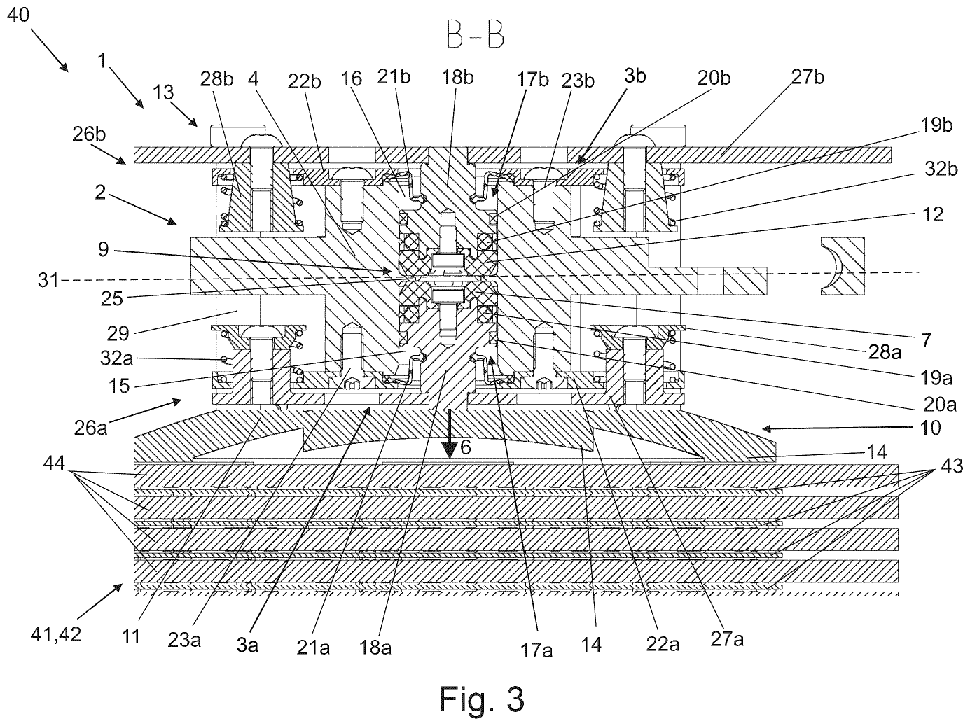

The annular housing 2 includes a plurality of, for example, six, housing portions 4, and a pressure chamber 9 (ref. FIG. 3) that can be filled with a fluid is located in each housing portion 4. The pressure chambers 9 in the annular housing 2 are fluidically connected to one another by at least one flow channel which is integrated in the annular housing 2. The annular housing 2 has a fluid inlet 8 (ref. FIG. 1) through which the fluid can be introduced into the flow channel and into the pressure chambers 9. The fluid is different from the wet room fluid located in the transmission housing. The multi-piston disengagement system 1 can be attached to the transmission housing via a plurality of fastening interfaces 33, which are arranged on the annular housing 2 at a distance from one another in the direction of rotation around the main axis 5. The fastening interfaces 33 are designed as screw devices. By fastening the annular housing 2 to the transmission housing, braking torques can be diverted to the transmission housing when the brake device 41 is actuated.

FIG. 3 shows a sectional view of the brake mechanism from FIG. 2 along the section line B-B. The outer plates 44 and the inner plates 43 of the disc pack arrangement 42 of the brake device 41, a housing section 4 of the annular housing 2 of the multi-piston disengagement system 1, and actuating arrangements 3a, 3b of the multi-piston disengagement system 1 can be seen.

The housing section 4 has exactly one pressure chamber 9, which is introduced into the housing section 4. The pressure chamber 9 includes a first pressure chamber section 15 and a second pressure chamber section 16, which are fluidically connected to one another. The pressure chamber sections 15, 16 are separated from one another in sections by an end stop 25 formed by a wall of the housing section 4.

A first actuating arrangement 3a and a second actuating arrangement 3b are assigned to the housing section 4. With respect to a plane 31 perpendicular to the main axis 5, which plane separates the two housing sections 15, 16 from one another in sections and extends through the end stop 25, the two actuating arrangements 3a, 3b are arranged and/or formed opposite one another in mirror image.

The first actuating arrangement 3a includes a first piston assembly 17a with a first piston 18a. The second actuating arrangement includes a second piston assembly 17b with a second piston 18b. A first guide body 7 is screwed to the first piston 18a and a second guide body 12 is screwed to the second piston 18b.

The first piston 18a and the first guide body 7 are arranged together in the first pressure chamber section 15 to be movable in the axial direction 6, wherein the first guide body 7 guides the first piston 18a. The second piston 18b and the second guide body 12 are arranged together in the second pressure chamber section 16 to be movable in an axially opposite direction, wherein the second guide body 12 guides the second piston 18b.

Each actuating arrangement 3a, 3b includes a sliding band seal 19a, 19b, a further seal 20a, 20b, and an axial-translational seal 21a, 21b. The sliding band seals 19a, 19b and the other seals 20a, 20b are designed as O-rings and are arranged in an immovable manner on the respective piston 18a, 18b. They seal the respective pressure chamber section 15, 16 during the movement of the piston 18a, 18b. The axial-translational seals 21a, 21b seal the respective pressure chamber section 15, 16 against the transmission housing filled with the wet space fluid.

The actuating arrangement 3a includes a retaining plate 22a which is arranged in the axial direction 6 on the housing section 4 and is screwed thereto by means of two screws 23a. The second actuating arrangement 3b has a second holding plate 22b, which is arranged in the axially opposite direction on the housing section 4 and is screwed thereto by means of two screws 23b.

In the case of a hydraulic pressurization, the first piston 18a can perform an actuating stroke in the axial direction 6 relative to housing section 4 and to the first retaining plate 22a attached thereto by means of the fluid introduced into pressure space 9. By means of the actuating stroke, the first piston 18a is transferred into a first actuating position in which the brake device 41 is actuated.

In the case of a hydraulic pressurization, the second piston 18b can perform an actuating stroke in the axial opposite direction relative to the housing section 4 and to the first retaining plate 22b attached thereto by means of the fluid introduced into the pressure chamber 9. The actuating stroke moves the second piston 18b into a second actuating position in which the brake device 41 is actuated.

The first actuating arrangement 3a has a first spring assembly 26a and the second actuating arrangement 3b has a second spring assembly 26b. The first spring assembly 26a includes a first spring sheet 27a and two first spring plates 28a, and the second spring assembly 26b includes a second spring sheet 27b and two second spring plates 28b. The first spring sheet 27a is arranged in the axial direction 6 in front of the first holding plate 22a, and the second spring sheet 27b is arranged in the opposite axial direction in front of the second holding plate 22b. Each retaining plate 22a, 22b has recesses through which spring plates 28a, 28b protrude. The spring plates 28a, 28b are of a truncated conical shape and are screwed to the respective spring sheet 27a, 27b. Each spring assembly 26a, 26b has two spiral springs 32a, 32b which are arranged on and surround the corresponding spring plates 28a, 28b. The spiral springs 32a, 32b are supported with one end on the respective holding plate 22a, 22b and with the other end on support surfaces of the respective spring plates 28a, 28b.

The first piston 18a is connected to the first spring sheet 27a in a form-fitting or force-fitting manner. During the actuating stroke of the first piston 18a, the first spring sheet 27a is moved together with the respective spring plates 28a in the axial direction 6 against a preloading of the respective spiral springs 32a. The spiral springs 32a act as return devices which return the first piston 18a axially in the opposite direction to the starting position when the hydraulic pressure is released.

The second piston 18b is connected to the second spring sheet 27b in a form-fitting and/or force-fitting manner. During the actuating stroke of the second piston 18b, the second spring sheet 27b is moved in the axial opposite direction together with the respective spring plates 28b against a preloading of the respective coil springs 32b. The spiral springs 32b act as return devices which return the second piston 18b axially to the starting position when the hydraulic pressure is released.

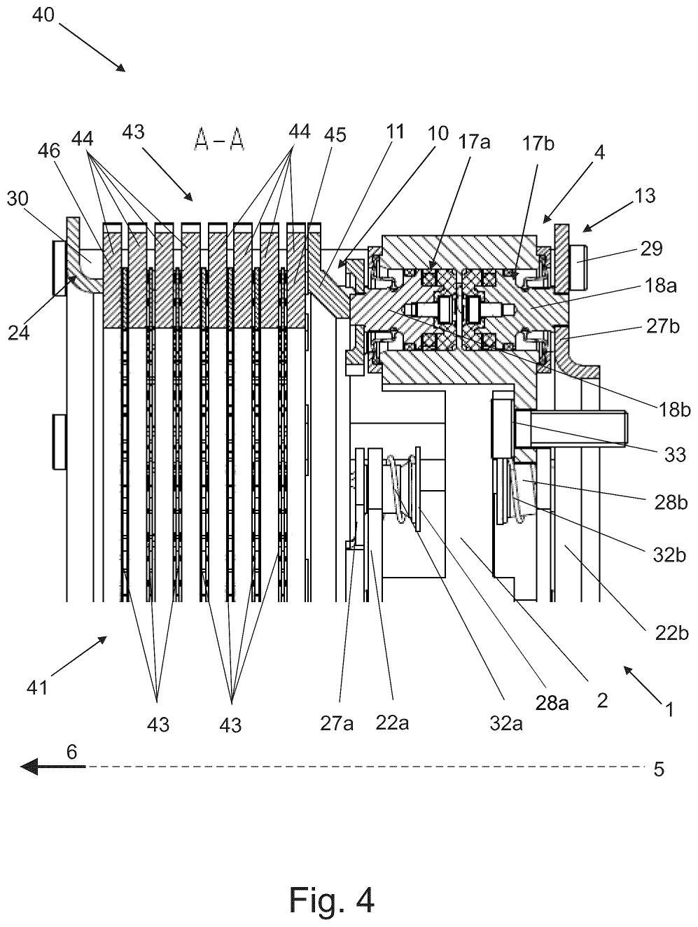

The first actuating arrangement 3a includes a force distribution device 10 for distributing and transmitting the actuating force of the first piston 18a to the friction disc pack arrangement 42. The force distribution device 10 is arranged in the axial direction 6 immediately in front of the first piston 18a. During the actuating stroke thereof, the first piston 18a presses against the force distribution device 10 so that it is moved together with the first piston 18a in the axial direction 6. The force distribution device 10 includes a force distribution ring 11 which is arranged to be concentric and/or coaxial to the annular housing 2 with respect to the main axis 5. The force distribution ring 11 has a plurality of force introduction regions 14. In the actuating position of the first piston 18a, the force introduction regions 14 press against an outermost outer plate 45 (ref. FIG. 4) arranged in the axially opposite direction, and thus introduce the actuating force transmitted by the first piston 18a thereinto in an axially directed manner. The force distribution ring 11 has an external toothing with which the force distribution device 10 can engage in corresponding internal toothings of the transmission housing of the transmission. As a result, the force distribution device 10 is secured in the transmission housing in a rotationally fixed manner and is arranged to be movable in the axial direction 6.

The second actuating arrangement 3b has a pressure transmission device 13 for transmitting and introducing the actuating force of the second piston 18b into the friction disc pack arrangement 42. The pressure transmission device 13 can be seen in different perspectives in FIGS. 1, 2, and 4. In FIG. 4, the figure shows a cross-section of the brake mechanism 40 from FIG. 2 along the section line A-A.

The pressure transmission device 13 includes at least one connecting device 29, which is designed as a plurality of connecting rods. The connecting rods run from the second actuating arrangement 3b of the multi-piston disengagement system 1 in the axial direction 6 to an outermost plate 46 of the disc pack arrangement 42 in the axial direction 6. For this purpose, the connecting rods extend through the disc pack arrangement 42, e.g., through the outer discs 44. Each connecting rod is connected in a form-fitting and/or force-fitting manner to a traction device 30 designed as a tension rod, e.g., pressed by a press connection 24. The traction device 30 encompasses the disc pack arrangement 42, e.g., the outermost outer disc 46 in the axial direction 6, at least in sections.

The connecting device 29 is operatively connected to the second spring sheet 27b, e.g., is screwed. As a result, the connecting device 29 is driven together with the second spring sheet 27b in the axial opposite direction when the second piston 18b carries out the actuating stroke. The traction device 30 is carried along by the connecting device 29 during the actuating stroke of the second piston 18b and is moved in the axially opposite direction, so that it assumes a pressure position in which it presses axially in the opposite direction against the outermost outer plate 46 in the axial direction 6 and in a frictional-fitting manner engages the plates 43, 44 of the disc pack arrangement 42 to one another to generate the braking force.

Thus, the actuating forces of the two pistons 18a, 18b act as pressure forces from both sides on the disc pack arrangement 42. A force level of the brake device 41 can thereby be increased and an external force flow, e.g., to the transmission housing, can be avoided.

### REFERENCE NUMERALS

1 Multi-piston disengagement system
2 Annular housing
3a First actuating arrangement
3b Second actuating arrangement
4 Housing section
5 Main axis
6 Axial direction
7 First guide body
8 Fluid inlet
9 Pressure chambers
10 Force distribution device
11 Force distribution ring
12 Second guide body
13 Pressure transmission device
14 Force introduction regions
15 First pressure chamber section
16 Second pressure chamber section
17a First piston assembly
17b Second piston assembly
18a First piston
18b Second piston
19a, b Sliding band seals
20a, b Additional seals
21a, b Axial-translational seals
22a First retaining plate
22b Second retaining plate
23a, b Screws
24 Press connection
25 End stop
26a First spring assembly
26b Second spring assembly
27a First spring sheet
27b Second spring sheet
28a First spring plate
28b Second spring plate
29 Connecting device
30 Traction device
31 Plane
32a, b Spiral springs
33 Fastening interfaces
40 Brake mechanism
41 Brake device
42 Disc pack arrangement
43 Inner disc
44 Outer disc
45 Outermost outer disc in opposite axial direction
46 Outermost outer disc in axial direction
47 External toothing
48 Internal toothing

1. A multi-piston disengagement system for a brake mechanism of a vehicle,
having an annular housing, wherein the annular housing has a main axis, wherein the main axis defines an axial direction,
wherein the annular housing comprises a plurality of housing sections, wherein a pressure chamber which can be filled with or is filled with a fluid is arranged in each housing section,
having a plurality of hydraulic actuating arrangements, wherein each actuating arrangement has a piston assembly with a hydraulically movable piston, wherein the respective piston can carry out an actuating stroke for introducing an actuating force into a brake device of the brake mechanism when subjected to hydraulic pressure,
wherein:
each housing section is assigned a first actuating arrangement having a first piston assembly and a second actuating arrangement having a second piston assembly, wherein the first piston assembly comprises a first piston and the second piston assembly comprises a second piston.

2. The multi-piston disengagement system according to claim 1, wherein exactly one pressure chamber is arranged in each housing section, wherein the first piston and the second piston are arranged to be hydraulically movable in the pressure chamber.

3. The multi-piston disengagement system according to claim 1, wherein the first piston can carry out the actuating stroke in the pressure chamber in the axial direction, and the second piston can carry out the actuating stroke in the pressure chamber in an axial opposite direction.

4. The multi-piston disengagement system according to claim 1, wherein the pressure chamber comprises a first pressure chamber section and a second pressure chamber section, wherein the first pressure chamber section is fluidically connected to the second pressure chamber section, wherein the first piston is arranged to be hydraulically movable in the first pressure chamber section and wherein the second piston is arranged to be hydraulically movable in the second pressure chamber section.

5. The multi-piston disengagement system according to claim 4, wherein a plane perpendicular to the main axis is arranged between the first pressure chamber section and the second pressure chamber section, wherein the first actuating arrangement and the second actuating arrangement are arranged or formed opposite one another or in mirror image with respect to the plane, or wherein the first actuating arrangement and the second actuating arrangement are arranged axially or radially offset from one another with respect to the plane.

6. The multi-piston disengagement system according to claim 1, wherein the multi-piston disengagement system comprises a pressure transmission device for transmitting or introducing the actuating force transmitted by the second piston to/into a disc pack arrangement of the brake device.

7. The multi-piston disengagement system according to claim 6, wherein the pressure transmission device comprises at least one connecting device and a traction device operatively connected to the connecting device, wherein the connecting device and the traction device are movable in the axial opposite direction during the actuating stroke of the second piston, and wherein the at least one traction device is transferable into a pressure position for exerting a pressure force directed in the axial opposite direction against the disc pack arrangement during the actuating stroke of the second piston.

8. A brake mechanism for a vehicle having the multi-piston disengagement system according to claim 7, wherein the brake device comprises a disc pack arrangement having a plurality of friction discs.

9. The brake mechanism according to claim 8, wherein the at least one connecting device extends in the axial direction through the disc pack arrangement, wherein the at least one traction device encompasses the disc pack arrangement at least in sections, and can exert a compressive force against the friction discs of the disc pack arrangement during the actuating stroke of the second piston.

10. A transmission arrangement for a vehicle, wherein the transmission arrangement comprises a transmission housing, a transmission, and the brake mechanism according to claim 8, wherein the transmission and the brake mechanism are accommodated in the transmission housing.

11. A multi-piston disengagement system for a vehicle brake mechanism, comprising an annular housing, the annular housing comprising:
a main axis defining an axial direction and an axial opposite direction; and
a plurality of housing sections, each of the plurality of housing sections comprising:
a pressure chamber arranged to be filled with a fluid; and
an actuating arrangement comprising:
a first piston assembly comprising a first piston that, when subjected to a hydraulic pressure, is movable in a first actuation stroke to introduce a first actuating force into a brake device of the vehicle brake mechanism; and
a second piston assembly comprising a second piston that, when subjected to a hydraulic pressure, is movable in a second actuation stroke to introduce a second actuating force into the brake device of the vehicle brake mechanism.

12. The multi-piston disengagement system of claim 11 wherein:
the first piston and the second piston are arranged in the pressure chamber; and
the first piston and the second piston are both hydraulically movable in the pressure chamber.

13. The multi-piston disengagement system of claim 11 wherein:
the first actuation stroke is in the axial direction; and
the second actuation stroke is in the axial opposite direction.

14. The multi-piston disengagement system of claim 11, wherein:
the pressure chamber comprises:
a first pressure chamber section; and
a second pressure chamber section fluidically connected to the first pressure chamber section;
the first piston is hydraulically movable in the first pressure chamber section; and
the second piston is hydraulically movable in the second pressure chamber section.

15. The multi-piston disengagement system of claim 14 wherein the first pressure chamber section and the second pressure chamber section are arranged in a mirror image opposite one another with respect to a plane extending perpendicular to the main axis and between the first pressure chamber section and the second pressure chamber section.

16. The multi-piston disengagement system of claim 11 further comprising a pressure transmission device for transmitting the second actuating force to a disc pack arrangement of the brake device.

17. The multi-piston disengagement system of claim 16 wherein the pressure transmission device comprises:
a connecting device; and
a traction device operatively connected to the connecting device, wherein:
the connecting device and the traction device are movable in the axial opposite direction during the second actuation stroke; and
the traction device is arranged to exert a pressure force against the disc pack arrangement in the axial opposite direction during the second actuation stroke.
